(19) United States
(12) Patent Application Publication
(10) Pub. No.: US 2010/0116354 A1
(43) Pub. Date: May 13, 2010

(54) Liner for spill continment manholes

(76) Inventor: John William Rowe, Oroville, CA (US)

Correspondence Address: John W. Rowe, 5523 Baggett Marysville Road, Oroville, CA, 95965, US

(21) Appl. No.: 12/291,691

(22) Filed: Nov. 13, 2008

(51) Int. Cl. F16K 51/00

(52) U.S. Cl. 137/312

(57) ABSTRACT

A method of repairing a leaking spill container by lining the existing unit. Additionally the liner can be used to convert a single walled spill container into a double walled spill container.

### FIELD OF THE INVENTION

The present invention relates to containment of fluids and, more particularly, to the containment of fluids in overfill or spill containers.

### BACKGROUND OF THE INVENTION

Prior to 1988 the US EPA determined that significant pollution was occurring in the US due to fuel leaking from a number of sources at fueling facilities (gas stations). Tanks, piping from tanks to dispensers, fuel leaks at the dispensers and fuel discharges caused by overfilling tanks and from fuel remaining in the filling hoses all contributed to pollution at fueling facilities. The US EPA established guidelines for upgrading fueling facilities including requiring a means of catching fuel discharged in the process of filling the tanks. These catchment basins came to be know as “Spill Containers”, “Spill Containment Manholes”, “Spill Containment Buckets” and a host of other similar descriptions. Some spill containers were and are manufactured out of welded metal. Other less expensive spill containers were and are manufactured using a plastic bellows. The plastic bellows style of spill container became the popular choice and is found at most fueling facilities today.

Over time spill containers themselves have started leaking. Some States have now regulated the testing and certifying of the spill containers on a periodic basis. As an example, the State of Alabama has started requiring that spill containment manholes be hydrostatically tested. Any leaking spill container must be repaired or replaced or the service station can be shut down until the offending spill container can be replaced. Since the installation of the first spill containment manholes in the late 1980's there has been a need for an inexpensive repair of leaking spill containers.

Presently the only known solution is to replace the manhole with a new one.

Replacing an existing spill containment manhole is an expensive process requiring in most instances that at least part of the site be closed while repairs are being performed. Excavating equipment is required, concrete must be broken and removed and a new spill container must be purchased and installed. Delays may be encountered to obtain permits. My recent survey, conducted in 2008, of replaced spill containers indicates the cost is approximately $4500 per unit. This cost does not account for lost fuel revenues, costs of permits and any clean up costs associated with the uncovering of contaminated soils surrounding the leaking spill container.

It would be advantageous to provide a liner that is fuel resistant.

It would also be advantageous to provide a liner that can be made to closely match the inside of the existing spill container so as to minimize the loss of capacity of the spill container once the liner is in place.

It would also be advantageous to provide a liner that can create a total seal between the snow plow ring installed on the surface of the fueling facility and the riser pipe extending from the fuel tank.

It would also be advantageous if the cost of the liner installed is a fraction of replacing the spill container.

It would also be advantageous if the spill container can be repaired without breaking concrete or using construction equipment.

It would also be advantageous if the liner could be installed within a few hours by a single technician.

It would also be advantageous if the liner could be coated with a film of material that is highly chemically resistant to the liquids to be encountered.

It would further be advantageous if the liner could be used to convert an existing single walled spill container to a double walled spill container.

### SUMMARY OF THE INVENTION

In accordance with the present invention, there is provided a method of repairing a leaking spill containment manhole by lining the existing unit. Additionally the liner can be used to convert a structurally sound single walled spill containment manhole into a double walled spill containment manhole.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a cross section view of an existing spill container with a plastic bellows;

FIG. 2 is a cross section view of an existing spill container with a metal body;

FIG. 3 is a cross section view of the components required to manufacture a liner;

FIG. 4 is a cross section view of a bellows style spill container with a drain valve mounted on a tank riser;

FIG. 5 is a cross section view of a bellows style spill container where fill has been added to cover the irregular shape of the bottom of the spill container;

FIG. 6 is a cross section view of an of the liner showing the coated surface, ready to be installed in a bellows style spill container; and

FIG. 7 is a cross section view of a bellows style spill container with the liner installed.

For purposes of clarity and brevity, like elements and components will bear the same designations and numbering throughout the Figures.

### DESCRIPTION OF THE PREFERRED EMBODIMENT

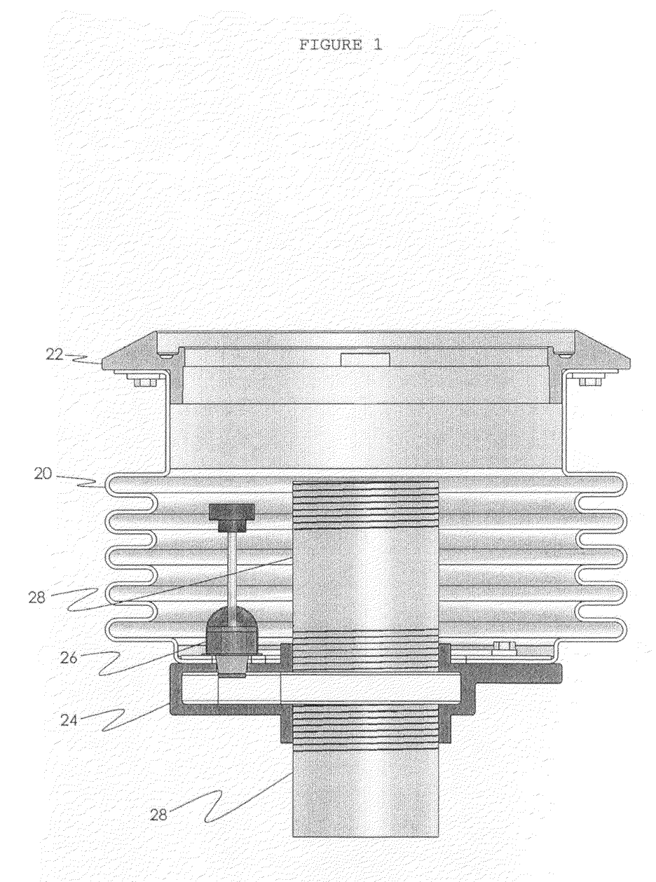

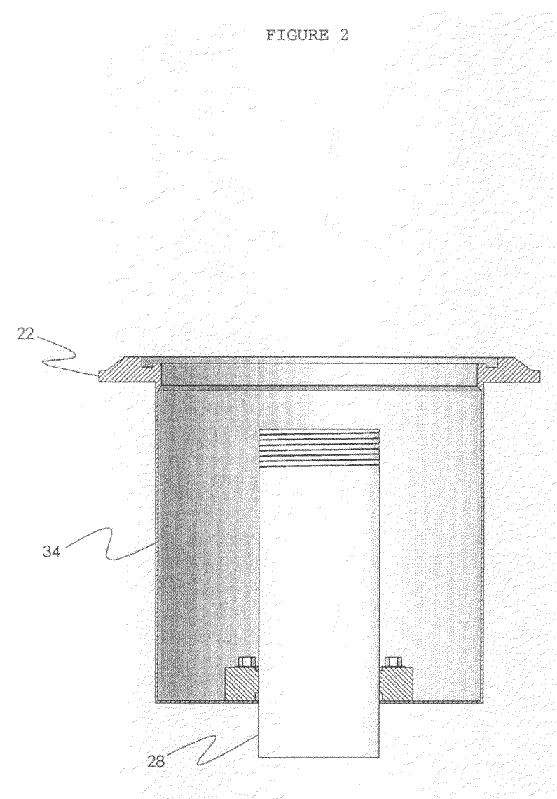

This invention is best understood by referring initially to existing spill containment manholes in FIG. 1 and FIG. 2. FIG. 1 is a cross section view of a spill containment manhole with a bellows 20 style body, a snow plow ring 22 (common to most spill containers), a base 24 (common to most spill containers), a drain valve 26 (common to most spill containers) and a tank riser 28 (common to all spill containers). FIG. 2 is a cross section view of a spill containment manhole with a metal body in lieu of the bellows 20-style body shown if FIG. 1. The spill containment manhole in FIGS. 1 and 2 are connected to a 4″ tank riser 28 extending from the top of the buried fuel tank. The surface of a fueling facility is covered with a concrete slab. The snow plow ring 22 is mounted more or less flush with the top of the concrete slab. Attached to the snow plow ring 22 is the rest of the spill container. The bellows 20 is normally attached to the underside of the snow plow ring 22 by means of bolts through a lip on the top of the bellows 20 terminating into the bottom of the snow plow ring 22. The bellows 20 is terminated to the base 24 in any number of manners including bolts, band clamps or other securing devices. The riser inside the spill container is terminated into the base 24 of the spill container. Often a drain valve 26 is installed in the base 24 so that liquids captured in the spill container may be drained into the tank riser 28. All seams or joints created at the junction of the various components may create leak paths. Spill containers that incorporate a plastic bellows 20 have proven to have a high failure rate of the bellows 20 itself. There are at least nine different spill containment manufacturers and each may have multiple configurations of their spill containers. It is not necessary to identify all the permutations that may be encountered in the field. FIGS. 1 and 2 represent cross sections of typical spill containers encountered in the industry. Irrespective of the cause and location of a failed, (leaking) spill container or the configuration of the spill container, my invention provides means for repairing these spill containers.

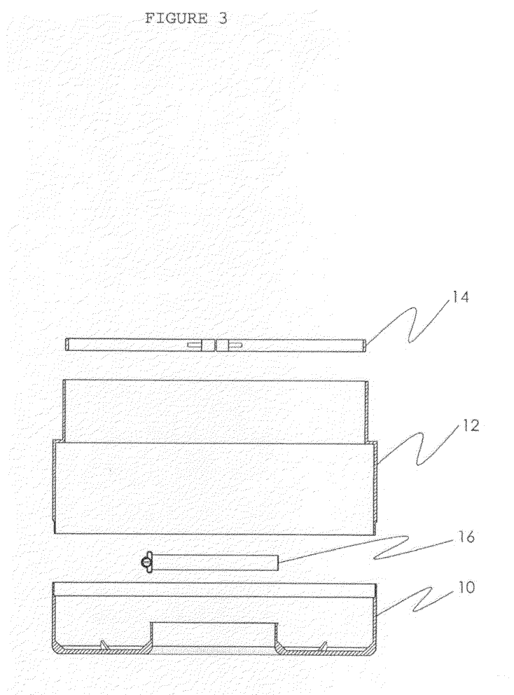

FIG. 3 is a cross section view of the components of a liner 30. When the liner top 12, is joined to the liner bottom 10, the liner 30 is created. In some instances the liner 30 may be manufactured as a single component. Such a liner 30 could be fitted into FIG. 2 and function as designed. However most spill containers have a mouth opening smaller than the diameter of the bellows 20 section of the spill container as shown in FIG. 1. It is preferred that the liner 30 fit the interior profile of the spill container as liner 30 needs to be as large as possible so as to not unduly reduce the capacity of the spill container. Large “collapsing core” molds could be made to manufacture the various liners in one piece. It is preferred however, to manufacture the liner 30 from two or more segments. It is preferred to manufacture a separate liner bottom 10 and a separate liner top 12 and join the components by a suitable connecting method. In that manner the tooling required to make all the configurations of liners required can be minimized. The bottom from one liner 30 and the top from another liner 30 may be joined to form a third liner 30. In the preferred embodiment, a bonding agent is used to bond the liner 30 to the snow plow ring 22 and to the tank riser 28. While bonding is not required it is a highly recommended procedure that assures a long lasting product requiring little maintenance. The liner 30 material should be chemically resistant to the liquids to be encountered. The liner 30 should be able to be bonded a to the mating spill container and tank riser 28 surfaces as well as being able to be bonded together. One such material that has been tested by Underwriters Laboratories for use in secondary containment applications at fueling sites is Pellethane 2355-85ABR available from Dow Chemical Co. Additionally the liner 30 may have a coating 36 applied. A suitable coating 36 material is used to make the liner 30 chemically more resistant to the specific fluids to be contained. A polysulfide liquid is available from Diversified Products Manufacturing Inc., part number DBF II. It is a suitable material for applications where motor fuels are to be encountered. Polysulfide has been used for years to coat the inside of fuel cells in aircraft.

FIG. 3 also shows an expanding compression ring 14. While the expanding compression ring 14 is not required, the preferred embodiment uses the expanding compression ring 14 to apply mild pressure to bonding surface A 18 while the bonding agent is curing. After the bonding agent has cured, approximately 30 minutes in the preferred embodiment, the expanding compression ring 14 may be removed and used on the next installation. The expanding compression ring 14 may be made of any suitable material, plastic, metal or wood etc.

The band clamp 16 in FIG. 3 is used to tighten the liner 30 to the tank riser 28. In the preferred embodiment the liner 30 is bonded to the riser then clamped to hold the liner 30 to the tank riser 28 while curing. The band clamp 16 while not essential is preferred. Any properly sized all stainless band clamp 16 in the market today will work for this application. Such a clamp is available from Norton Industries Inc., part number 035BR072-04, which fits 4″ tank risers.

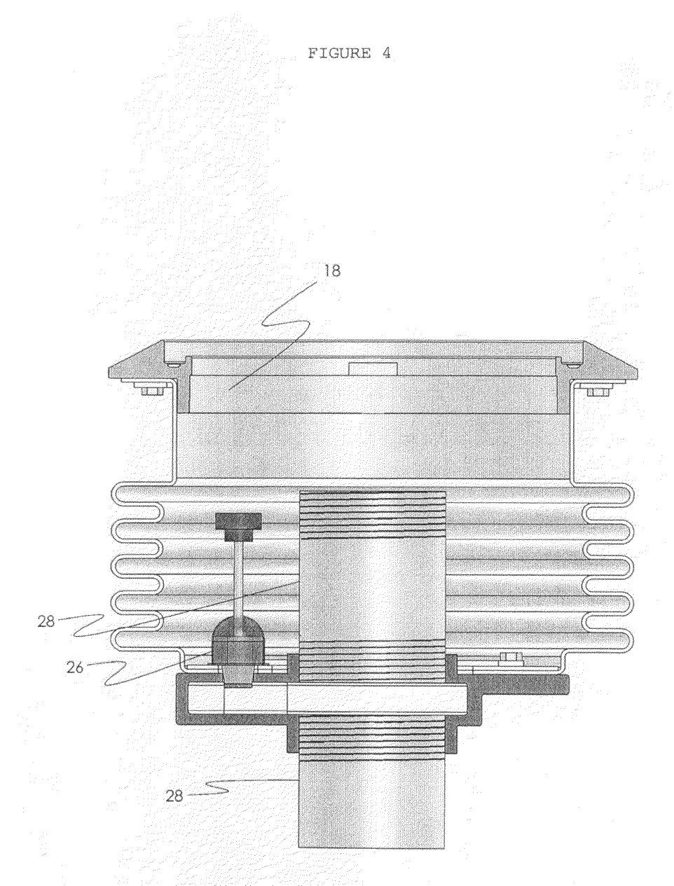

FIG. 4 shows the cross section of a spill container to be repaired and the areas requiring preparation prior to the installation of the liner 30. The liner 30 may be bonded to the spill containment snow plow ring 22 at bonding surface A 18. A second bonding surface B 34 is located on the tank riser 28. These surfaces, if bonded, require proper preparation for the bonding agents to be used. The preparation and bonding agent used is a function of the materials selected to manufacture the liner 30. In the preferred embodiment a Methyl Methacrylate is used. One such material is manufactured by available from Weld On, part number SS218 Stock #30110. It is anticipated that other bonding agents will be found that will perform as well as or better than the currently preferred product. Surface preparation for the preferred embodiment includes sanding bonding surface A 18 then cleaning with tetrachloroethylene. When the surfaces are clean and dry the bonding agent may be applied to the mating surfaces to be bonded. The drain valve 26 must be removed and the resulting hole plugged. Use a plug 40 with the same thread pattern as the removed drain valve 26. The plug 40 may be made of any material as it will be covered with a fill 38 during the installation process.

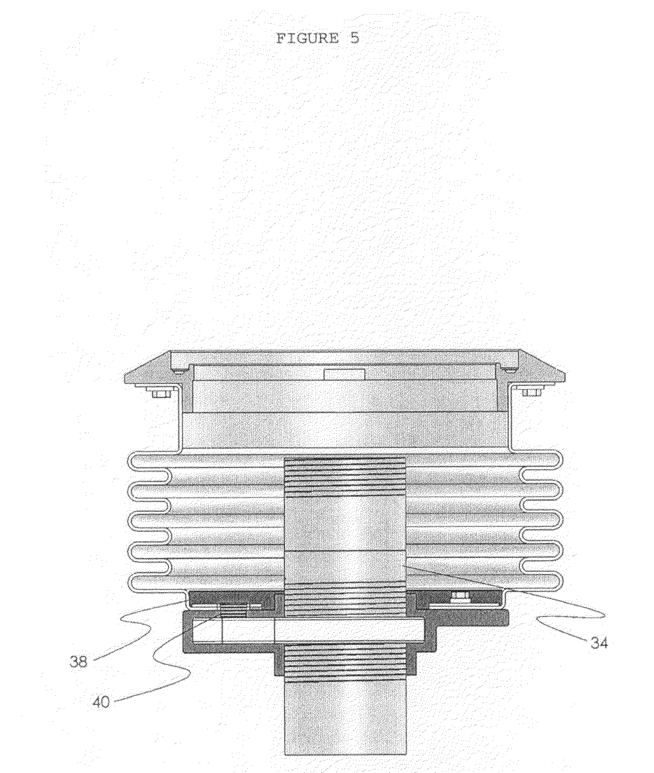

FIG. 5 is a cross section of the bellows 20 style spill container where fill 38 has been added to cover the irregular shape of the bottom of the spill container. It should be noted that the connection between the spill container and the tank riser 28 varies by manufacturer. Most spill containers have bolt heads that connect the bellows 20 to the body and/or some sort of compression coupling or screwed coupling or other means for joining the tank riser 28 to the spill container. These connection methods create an uneven surface at the bottom of the spill container. In order to make the repair easier, it is recommended that the uneven bottom of the spill container be leveled. The preferred embodiment of the invention uses a liquid form of polysulfide to fill 38 the bottom to a level above any irregularities encountered. The preferred polysulfide is a two part chemical that when mixed forms a permanent barrier to most fuels and bonds to metal and the liner 30 materials in the preferred embodiment. The preferred fill 38 material is available from Diversified Products Manufacturing Inc., Oroville, Calif. part number DBF II. While the fill 38 is not mandatory it is recommended in the preferred embodiment. Any liner 30 not using a fill 38 is subject to unnecessary wear and premature failure. Manufacturing a unique liner 30 for each manufacturer of spill container may be undertaken. However the tooling for this process would be unduly costly.

The cross section of FIG. 5 shows the spill container ready for the application of the bonding agent to the tank riser 28 and the subsequent installation of the liner 30. The surface of the tank riser 28 located under the clamping area should be cleaned prior to applying the bonding agent. Typically the tank risers are steel. When the riser is clean, apply the bonding agent to the bonding surface B 34 for approximately 1½″ above the polysulfide fill 38. The entire perimeter of the tank riser 28 should be covered with the bonding agent.

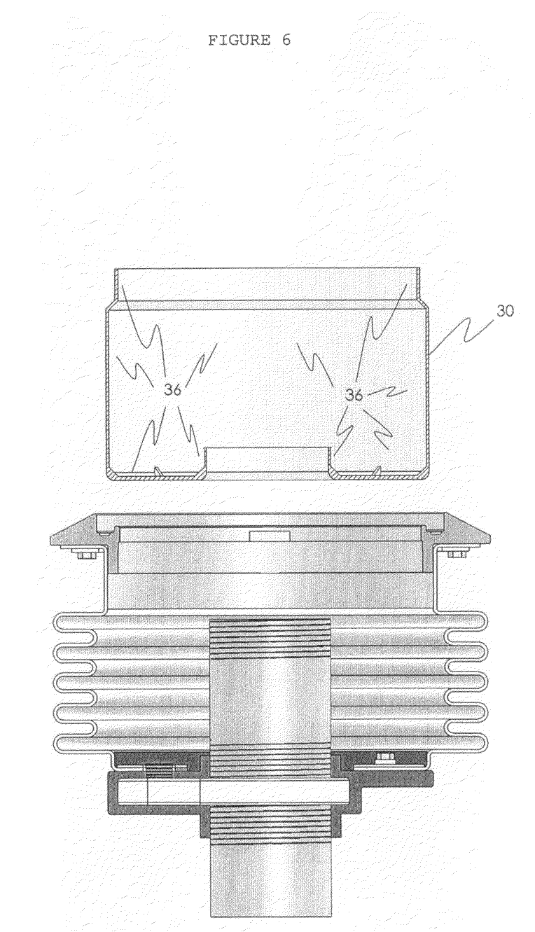

FIG. 6 is a cross section view of the liner 30 ready to be installed in a bellows 20 style spill container. In this embodiment, the liner top 12 and liner bottom 10 are shown as one piece. The liner 30 may be made up of one, two pieces, as shown in the preferred embodiment, or as many pieces as necessary to match the liner 30 to be spill container. In the preferred embodiment, the liner top 12 and liner bottom 10 and are joined together using a solvent welding process. The material used to manufacture the liner 30 is dissolved in a strong solvent, such as tetrahydrofuran, forming a pregnant solution. When this solution is applied to the mating and preferably overlapping surfaces of the liner top 12 and liner bottom 10, a solvent weld is created. The process of solvent welding is common knowledge and need not be reiterated here. The welded seam thus created is as strong as the liner top 12 or liner bottom 10. The liner 30 is collapsed when installed into the spill container shown in FIG. 6.

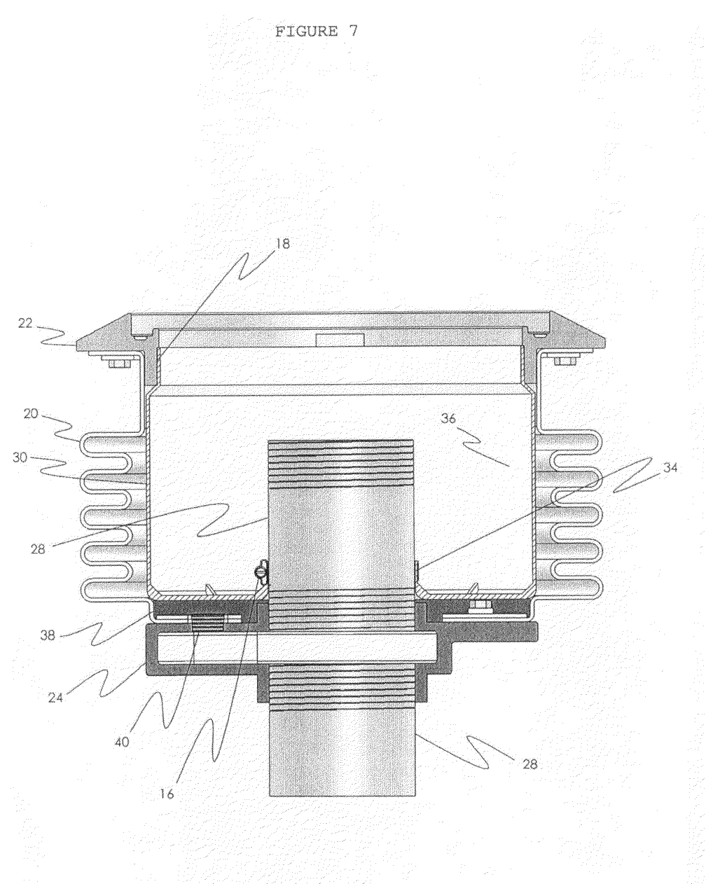

FIG. 7 is a cross section view of a bellows 20 style spill container with the liner 30 the installed. The top of the liner 30 should mate to the inside of the spill container's snow plow ring 22. The application of the bonding agent to bonding surface A 18 is applied at this time by folding down the collapsible liner 30 and running a bead of the bonding agent around the perimeter of the liner top 12 and mating surface of the snow plow ring 22. The top of the liner 30 may be held in place by an expanding compression ring 14 while the bonding agent cures. After curing of the bonding agent, the repair of the spill containment manhole is complete.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A liner for spill containment manholes for repairing existing leaking spill containment manholes or to provide double wall protection for new or existing single wall spill containment manholes, comprising:
means for containing spilled fluids.

2. The liner for spill containment manholes in accordance with claim 1, wherein said means for containing spilled fluids comprises a flexible membrane that may be collapsed while being installed into the spill container, has a surface for attaching to the snow plow ring, has a surface for attaching to the tank riser, is fuel resistant, may be coated with a highly fuel resistant material, may be manufactured with one or more sections that are bonded together to create the liner.
